(19) United States
(12) Patent Application Publication
(10) Pub. No.: US 2007/0231774 A1
(43) Pub. Date: Oct. 4, 2007

(54) OCCLUSAL DEVICE AND METHOD OF USE THEREOF FOR DIAGNOSTIC EVALUATION OF MAXILLOMANDIBULAR RELATIONSHIPS IN EDENTULOUS PATIENTS

(75) Inventor: Joseph J. Massad, Tulsa, OK (US)

Correspondence Address: HEAD, JOHNSON & KACHIGIAN, 228 W 17TH PLACE, TULSA, OK, 74119, US

(73) Assignee: GLOBAL DENTAL IMPRESSION TRAYS, INC., Tulsa, OK (US)

(21) Appl. No.: 11/754,009

(22) Filed: May 25, 2007

Related U.S. Application Data
(63) Continuation-in-part of application No. 11/247,840, filed on Oct. 11, 2005.
(60) Provisional application No. 60/618,066, filed on Oct. 12, 2004.

(51) Int. Cl. A61C 11/00

(52) U.S. Cl. 433/213

(57) ABSTRACT

A device for obtaining dental measurements to determine a patient's occlusal vertical dimension and centric relation position where these dental measurements are used to make dentures for the patient; and for obtaining dental measurements for balancing a patient's dentures and methods for making these dental measurements with the device. The device comprises a contact plate, a post, a ball nut, and a striking plate, where the combination of the contact plate being attached to the central lingual surface of the lower base plate, the ball nut being swivelably attached in a tapered opening in the contact plate, the post being adjustably secured to the ball nut; and the striking plate being attached to the central lingual surface of the upper base plate, are received in the mouth of the patient such that they cooperate with each other to obtain dental measurements including, but not limited to, occlusal vertical dimension, centric relation position, or measurements for balancing a patient's dentures.

This application is a continuation-in-part of U.S. patent application Ser. No. 11/247,840 filed on Oct. 11, 2005 which claims priority to U.S. Provisional Application No. 60/618,066 filed on Oct. 12, 2004.

### BACKGROUND OF THE INVENTION

1. Field of the Invention

The present invention relates to measurements as used in dental practice, devices for making these measurements during the fabrication and management of dentures, and methods for making these measurements during the fabrication and management of dentures.

2. Prior Art

In dentistry, it is a common practice when treating patients that are missing teeth to restore missing dental structures with complete dentures (also referred to as full dentures), which includes an upper denture and a lower denture, or partial dentures (also referred to as partial prostheses). Prior to making new or replacement complete or partial dentures, clinicians must make measurements of patients' mouths and existing dental prostheses and record these measurements. After making new dental prostheses, clinicians should make appropriate measurements to verify the proper fit and relationships of the new dental prostheses.

Two important and common dental measurements involve the registration of occlusal vertical dimension and centric relation positions. Identifying and measuring appropriate occlusal vertical dimension and centric relation positions during treatment of edentulous patients is necessary for predictable and successful application of dental prostheses. Massad J J, Connelly M E, Rudd K D and Cagna D R: Occlusal device for diagnostic evaluation of maxillomandibular relationships in edentulous patients: A clinical technique, Journal of Prosthetic Dentistry 91:586-590, 2004. Many denture wearers experience gradual and continuous reduction of occlusal vertical dimension over time. This is primarily owing to deterioration of the denture-supporting tissue and to denture tooth wear. Accompanying the loss of occlusal vertical dimension is reduction of lower face height and compromised facial esthetics. Potential problems associated with increasing the occlusal vertical dimension during fabrication of a new dental device include altered phonetic and masticatory function, unacceptable facial appearance, muscular discomfort, accelerated alveolar bone loss, sore residual ridges, premature and excessively audible denture tooth contact, and exaggerated gagging. For patients wearing complete dentures that demonstrate insufficient occlusal vertical dimension, it is necessary to identify an appropriate occlusal vertical dimension prior to fabricating a new dental device. Diagnostic evaluation of the occlusal vertical dimension may be accomplished with the aid of one of several different intraoral devices that are available on the market.

Diagnostic modification of the occlusal vertical dimension prior to complete denture therapy is often indicated for patients who have worn an existing dental device for many years. For these patients, clinical examination may reveal the following conditions: severe decrease in lower face height yielding poor facial esthetics, inadequate fit of complete dentures, worn denture teeth, a clinically discernible deficiency in occlusal vertical dimension, an acquired protrusive maxillomandibular relationship, angular cheilitis, or temporo-mandibular joint sounds on auscultation. Traditionally, complete denture therapy is initiated by accomplishing standard impression procedures, generating definitive casts, and fabricating record bases and occlusion rims. Then, maxillomandibular records are made to register the appropriate horizontal and vertical jaw relationship. In evaluating lower facial esthetics, the influences of neuromuscular programming and habitual mandibular posturing may adversely bias clinical interpretation of the optimal vertical maxillomandibular relationship. Here, three clinical outcomes are possible; (1) registration of inadequate occlusal vertical dimension as influenced by a patient's existing condition, (2) registration of excessively increased occlusal vertical dimension in an attempt to optimize facial esthetics, or (3) registration of the therapeutically and esthetically appropriate occlusal vertical dimension. Existing neuromuscular programming may also interfere with establishing and measuring a stable and repeatable centric relation position.

To predictably measure the most appropriate vertical and horizontal maxillomandibular relationships for edentulous patients demonstrating reduced lower face height, it is necessary to base clinical judgment on diagnostically repeatable and reliable information. Modification of an existing dental device or duplicates of the existing dental device to increase occlusal vertical dimension permits direct clinical evaluation of proposed maxillomandibular relationships. Subsequent observations during this diagnostic phase yield information on patient comfort, functional tolerance, and esthetic acceptance of the new maxillomandibular relationships. Only when conditions are judged appropriate by the clinician and are acceptable to the patient should the fabrication of a new dental device be initiated.

After new dental prostheses have been fabricated, clinicians should make appropriate measurements to verify proper fit and relationships of the dental prostheses. In the case of complete dentures, it is important that occlusion is balanced to functionally stabilize the prostheses when the patient engages contact between the upper and lower teeth. If the complete dentures are balanced, all upper posterior teeth will contact lower posterior teeth when the patient bites down and when the patient grinds side-to-side and front-to-back. Traditional devices and methods for verifying that complete dentures are balanced involve time consuming and complicated procedures, in part, due to the cumbersome mechanical nature of the devices involved.

It is an object of the embodiments of the present invention to provide a device and a novel method for obtaining reliable and repeatable occlusal vertical dimension measurements and recordings for dental patients. The device and novel method are simple to use, comfortable for patients, and inexpensive.

Another object of the embodiments of the present invention is to use the same device and a novel method for obtaining reliable and repeatable centric relation positional measurements and recordings for dental patients.

Another object of the embodiments of the present invention is to use the same device and yet another novel method for reliably balancing the occlusion on complete dentures.

By meeting the above objectives, the invention will save time for both clinicians and patients; provide a dental device that fits patients, increases patient comfort, improves patients' facial esthetics, reduces patients' alveolar bone loss, and improves durability of dental prostheses; and reduce the time required to fabricate dental prostheses.

Other devices and methods of obtaining occlusal vertical dimension registrations, centric relation position measurements and balanced complete denture occlusions fail to provide uncomplicated and accurate dental recordings and procedures. The reason for this failure is that other devices and methods of obtaining these dental recordings are actually mechanically challenging for clinicians and yield dental measurements that are not truly representative of patients' conditions. These inaccurate dental measurements lead to the production of dental prostheses that fail to fit and function successfully. This, in turn, leads to discomfort and sometimes injury to patients. Other devices and methods of obtaining dental measurements provide inconsistent results and are time consuming for clinicians. Sometimes the devices and methods for obtaining the dental measurements provide satisfactory results. Other times the devices and methods for obtaining dental measurements provide results that are completely unsatisfactory, requiring the dental prostheses to be remade at the expense of either the clinician or the patient.

### SUMMARY OF THE INVENTION

An occlusal device for diagnostic evaluation of maxillomandibular relationships in edentulous patients comprises a contact plate, a post, a ball nut and a striking plate. The occlusal device allows the clinician to accurately obtain the patient's occlusal vertical dimension, centric relation position and other dental measurements.

The contact plate is capable of being attached to a central lingual surface of a lower base plate of the patient using an attachment mechanism. The contact plate may be located slightly below the occlusal plane of the patient's lower base plate, while a top surface of the contact plate may be parallel with the occlusal plane. In an embodiment, the contact plate may be substantially trapezoidal in shape. The contact plate should be constructed of materials to provide sufficient rigidity to prevent flexing of the contact plate while the clinician is taking the dental measurements. Further, the contact plate may have a beveled or rounded outer edge.

The contact plate has a tapered opening located substantially in the center, surrounded by an upwardly extending shoulder. The diameter of the tapered opening nearest the top surface of the contact plate may be greater than the diameter of the tapered opening nearest the bottom surface of the contact plate. Further, the tapered opening may have one or more notches or slots for receiving the attachment material to immobilize the ball nut relative to the contact plate prior to taking the dental measurements. The shoulder may be cylindrical in shape and may have a tapered face that cooperates with the tapered opening in the contact plate to swivelably attach the ball nut. The ball nut may be spherical with a cylindrical bore through a central axis of the ball nut.

The striking plate is capable of being attached to a central lingual surface of an upper base plate of the patient using the attachment mechanism, while a bottom surface of the striking plate is parallel with the occlusal plane of the upper base plate. In an embodiment, the striking plate may be substantially parabolic in shape. The striking plate may have at least one outwardly extending wing capable of being trimmed by the clinician so that the striking plate properly fits between the occlusal surfaces of the patient's upper base plate. A top surface of the striking plate may include at least one retention protrusion to engage the patient's upper base plate. Like the contact plate, the striking plate should be constructed of materials to provide sufficient rigidity to prevent flexing of the striking plate while the clinician is taking the dental measurements. Further, the striking plate may have a beveled or rounded outer edge.

The post may be adjustably secured to the ball nut such that a length of the threaded post is exposed above the top surface of the contact plate. The post may include a threaded exterior surface which may cooperate with a threaded, cylindrical bore in the ball nut. The length of the post may be adjusted to contact the bottom surface of the striking plate at a desired physiological rest position (“PRP”), occlusal vertical dimension (“OVD”), centric relation position (“CRP”) or other dental measurement. In an embodiment, the post may have a domed or terminal end and a slotted end, where the slotted end is opposite of the domed end.

In an embodiment, the occlusal device includes a plate spacer with an opening located substantially in the center to receive the post. Also, a bottom surface of the plate spacer may be constructed lie flush with the top surface of the contact plate while the post passes through the opening in the plate spacer. The plate spacer may also have a rounded or beveled outer edge.

A method of using the occlusal device to accurately obtain the patient's OVD, CRP, and other dental measurements is also contemplated herein. The clinician attaches the contact plate to the central lingual surface of the lower base plate slightly below the occlusal plane and the strike plate to the central lingual surface of the upper base plate slightly above the occlusal plane of the patient using an attachment material. The striking plate is then fitted between the occlusal surfaces of the patient's upper base plate by trimming the outwardly extending wings to ensure a proper fit in the patient's mouth. The post is secured into the ball nut so that the post has a length relative to the top surface of the contact plate. The ball nut is swivelably attached to the tapered opening in the contact plate. The upper base plate and the lower base plate are mounted in the patient's mouth so the clinician may measure the PRP. The clinician may use the plate spacer between the striking plate and the contact plate to aid in alignment. Based on the PRP, the length of the post is adjusted until a terminal end will contact the bottom surface of the striking plate nearest the point of the PRP of the patient. The ball nut is then adjusted until the post is substantially perpendicular to the striking plate when the PRP is maintained by the patient. The freeway space of the patient may then be decreased by adjusting the length of the post, preferably by one (1) to four (4) millimeters. This adjustment range is an estimate and will vary slightly depending on the individual patient. The patient's OVD, CRP or other dental measurements are then established and recorded. The clinician injects a bite registration material between the upper base plate and the lower base plate while the patient maintains contact between the post and the striking plate. Once the bite registration material is set, the occlusal device is carefully removed from the patient's mouth. The occlusal device should then be balanced to ensure proper occlusion in the patient.

In an embodiment, the clinician measures the PRP of the patient by placing a dot on the nose and chin of the patient as measurement points with a non-permanent marker and then instructs the patient to take a series of deep breaths. Once the patient is fully relaxed, the PRP is recorded by adjusting a caliper so that the point of each leg of the caliper touches the dot on the nose and on the chin. Once this is done, the clinician locks the caliper into the PRP position for future reference. Now, the clinician may decrease the patient's freeway space by adjusting the post by one (1) to four (4) millimeters inside the PRP represented by the caliper.

The occlusal device may be used to establish the OVD and the CRP of the patient by applying ink from an inking marker onto the bottom surface of the striking plate. Then, a repeatable CRP with the upper base plate and the lower base plate is established by instructing the patient to first tap the post against the striking plate, and second, while maintaining contact between the terminal end of the post and the bottom surface of the striking plate, instruct the patient to move their jaw forward and backward and from side to side until the CRP is traced in the shape of an arrow. The clinician may then align the terminal end of the post with the center point of the arrow by swiveling the ball nut, by resetting the physiological rest position, or a combination of both. The ball nut may be secured into a fixed position using an adhesive material.

To ensure proper fit, the occlusal device may be balanced in the mouth of the patient. The length of the post may be adjusted so that the terminal end of the post contacts the striking plate when the teeth of the patient are held just out of occlusion in all mandibular movements. A marking material, such as articulating pater, is applied above the occlusal surface, and then the patient is instructed to tap and rub their teeth together. The marking material will transfer marks on areas where the dentures prematurely contact. If pre-maturities exist, the clinician should remove the marked cusps or fossae using an equilibration bur or the like until proper occlusion is reached on all posterior teeth. Finally, the contact plate, the striking plate and any attachment material should be removed.

Other objects and advantages of the embodiments of the present invention will become apparent from the following descriptions, taken in connection with the accompanying drawings, wherein, by way of illustration and example, an embodiment of the present invention is disclosed.

### BRIEF DESCRIPTION OF THE DRAWINGS

FIG. 1 is a perspective view of an embodiment of the contact plate of the occlusal device;

FIG. 2 is a perspective view of another embodiment of the contact plate shown in FIG. 1;

FIG. 3 is a perspective view of an embodiment of the striking plate of the occlusal device;

FIG. 4 is a perspective view of another embodiment of the contact plate shown in FIG. 3;

FIG. 5 is a perspective view of an embodiment of the plate spacer of the occlusal device;

FIG. 6 is an assembled perspective view of an embodiment of the occlusal device;

FIG. 7 is a perspective view of an embodiment of the occlusal device shown in FIG. 6 including the plate spacer;

FIG. 8 is a perspective view of another embodiment of the occlusal device shown in FIGS. 6 and 7;

FIG. 9 is a top perspective view of the contact plate attached to the lower base plate;

FIG. 10 is a rear perspective view of the attached contact plate shown in FIG. 9;

FIG. 11 is a bottom perspective view of the striking plate attached to the upper base plate;

FIG. 12 is a front perspective view of a patient showing how to measure the patient's physiological rest position with a set of calipers;

FIG. 13 is a partial side perspective view of the striking plate attached to the upper base plate and the contact plate attached to the lower base and the post is in contact with the striking plate;

FIG. 14 is a partial bottom perspective view of the bottom surface of the striking plate being inked with an inking marker;

FIG. 15 is a partial bottom perspective view of the striking plate showing the desired tracing when taking the dental measurements of the patient;

FIG. 16 is a cross-sectional side view of the patient's mouth containing the occlusal device while a bite retention material is being injected;

FIG. 17 is a side perspective, in cross-section, view of the patient's mouth showing the removal of the finished record of the patient's proper occlusal vertical dimension and the centric relation position measurement captured with the use of the occlusal device;

FIG. 18 shows the bottom perspective view of the occlusal device with proper balance occlusion being determined by the existence of marks from the marking material that are evenly positioned on all posterior teeth; and

FIG. 19 shows the top perspective view of the occlusal device with proper balance occlusion being determined by the existence of marks from the marking material that are evenly positioned on all posterior teeth.

### DETAILED DESCRIPTION OF THE PREFERRED EMBODIMENTS

The embodiments discussed herein are merely illustrative of specific manners in which to make and use the invention and are not to be interpreted as limiting the scope of the instant invention.

While the invention has been described with a certain degree of particularity, it is to be noted that many modifications may be made in the details of the invention's construction and the arrangement of its components without departing from the spirit and scope of this disclosure. It is understood that the invention is not limited to the embodiments set forth herein for purposes of exemplification.

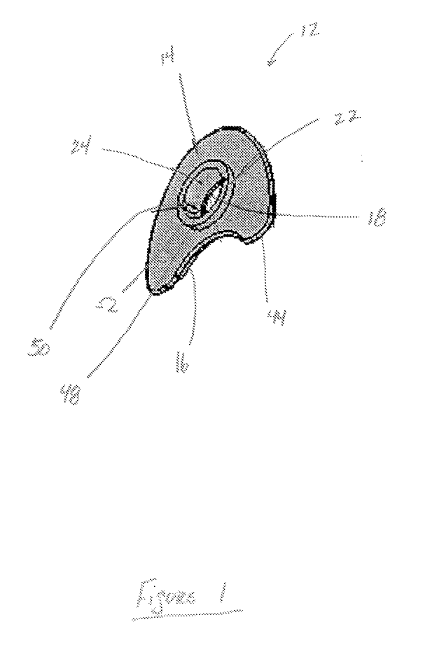

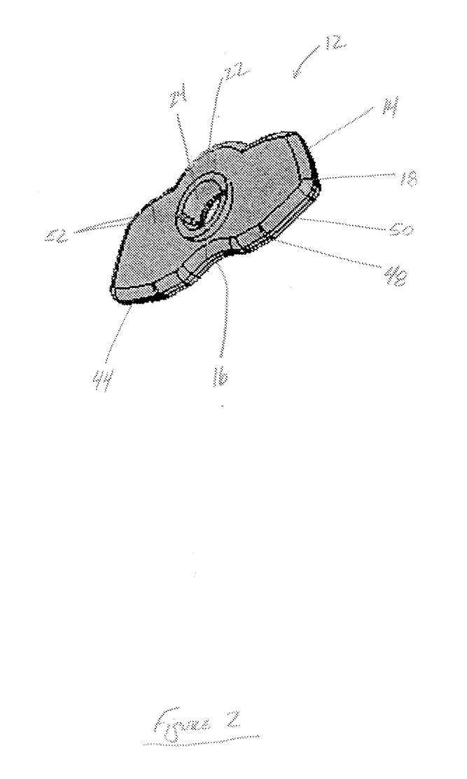

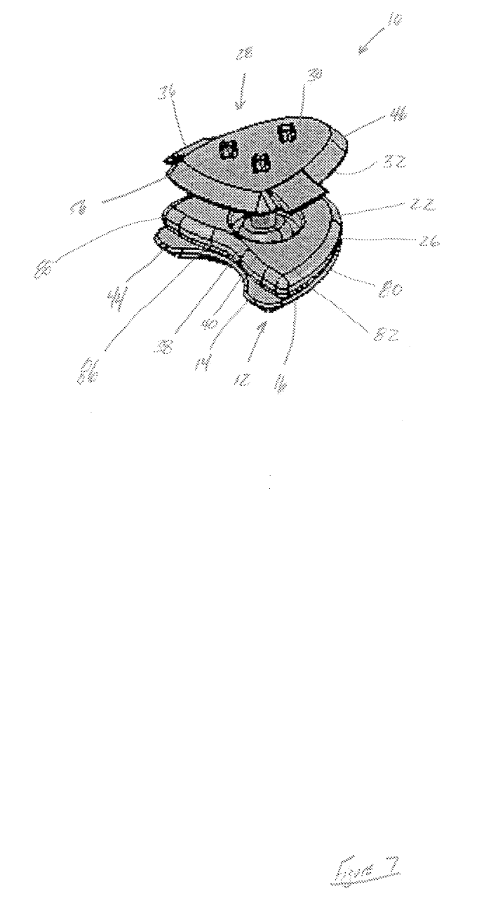

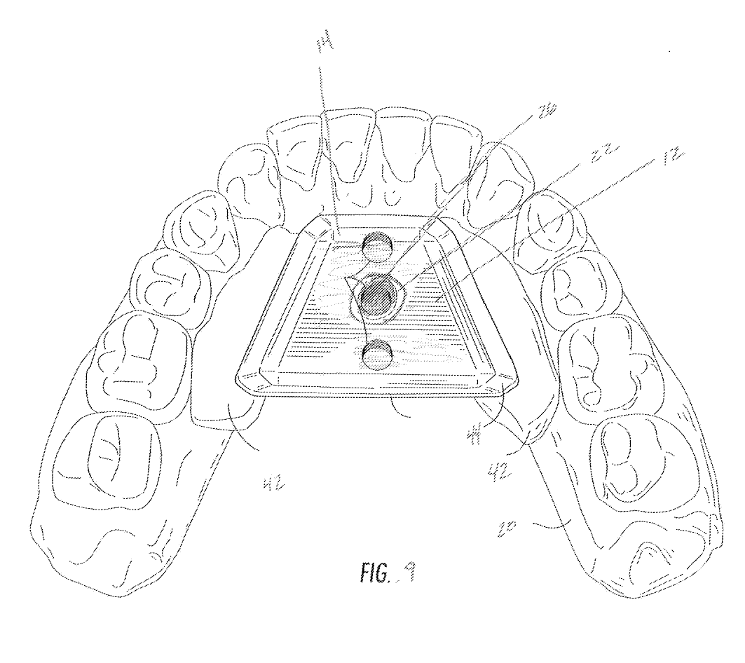

Referring to the figures of the drawings, wherein like numerals of reference designate like elements throughout the several views, particularly to FIGS. 1 through 8. FIGS. 1 and 2 illustrate a perspective view of different embodiments of the contact plate 12 used with the occlusal device 10 of the present invention. The contact plate 12 comprise a top surface 14 and a bottom surface 16. The contact plate 12 has a shape that is substantially capable of being attached to a central lingual surface of a lower base plate 20 of the patient as shown in FIG. 9. The contact plate 12 may be removably attached by an attachment material 42 to the central lingual surface of the patient's lower base plate 20. The contact plate 12 may also be located slightly below the occlusal plane the patient's lower base plate 20, such that the top surface 14 of the contact plate 12 is parallel to the occlusal plane. The attachment material 42 may be any medical grade bonding material, including but not limited to light-polymerized or auto-polymerizing materials, adhesive materials, bonding agents, dental waxes, medically approved super glues or other attachment materials commonly used in the dental industry. The contact plate 12 should be constructed of any polymeric or metal materials that are sufficiently rigid to prevent flexing of the contact plate 12 while the clinician is taking the patient's dental measurements. The contact plate 12 may also have a beveled or rounded edge.

Located substantially in the center of the contact plate 12 is a tapered opening 18. The tapered opening 18 may have a top diameter near the top surface 14 of the contact plate 12 that is greater than a bottom diameter near the bottom surface 16 of the contact plate 12. The tapered opening 18 may include one or more notches 52 or slots to receive an adhesive material 54 to immobilize the ball nut 26 before the clinician takes the patient's dental measurements. In addition, an extending upwardly shoulder 22 surrounds the tapered opening 18. The shoulder 22 has a tapered surface 24 that cooperates with the tapered opening 18 in the contact plate 12 allowing the ball nut 26 to be swivelably attached to the contact plate 12. In an embodiment, the shoulder 22 is cylindrical in shape, but those skilled in the art will appreciate that other shapes may be utilized in keeping with the spirit and scope of the present invention. The ball nut 26 may be spherical in shape and may have a cylindrical bore through a center axis.

A post 38 is adjustably secured to the ball nut 26 such that a length of the post 38 is exposed above the top surface 14 of the contact plate 12. The post 38 may be cylindrical or other shape. In one embodiment, the post 38 may be friction fit into a cylindrical bore through the ball nut 26, while in another embodiment, the post 38 has a threaded exterior surface. In this later embodiment, the ball nut 26 may include a threaded cylindrical bore there through such that the threads on the post 38 cooperate with the threads in the ball nut 26 to adjustable secure to the post 38. Those skilled in the art will appreciate the vast variety of mechanisms for securing the post 38 to the ball nut 26 while maintaining the spirit and scope of the embodiments of the present invention. The length 40 of post 38 may be adjusted to contact the bottom surface 32 of the striking plate 28 at a desired PRP, OVD, CRP or other dental measurement. In an embodiment, the post 38 may have a domed or terminal end and a slotted end, where the slotted end is opposite of the domed end.

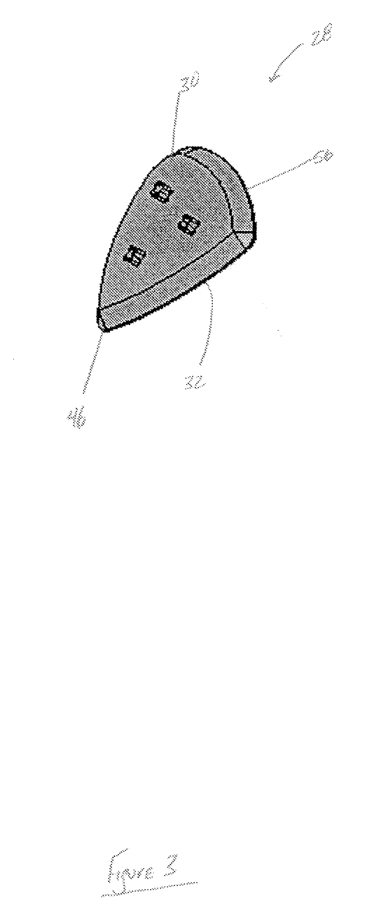

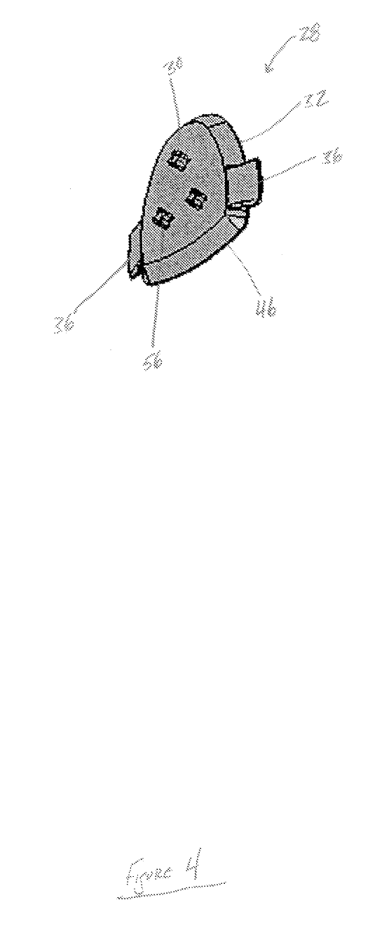

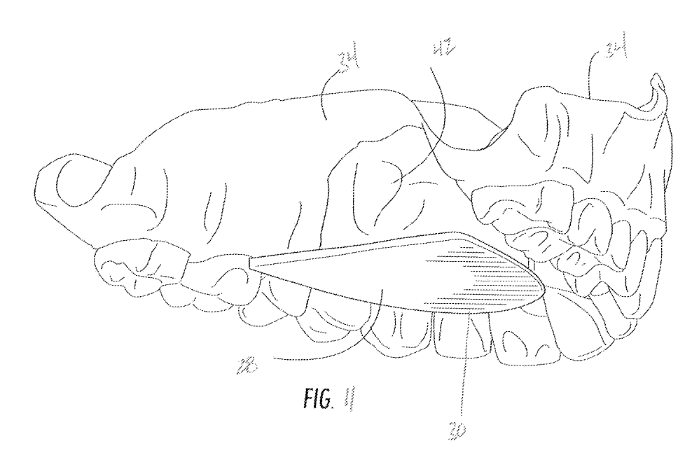

FIGS. 3 and 4 illustrate a perspective view of different embodiments of the striding plate 28 used with the occlusal device 10 of the present invention. The striking plate 28 comprises a top surface 30 and a bottom surface 32. The striking plate 28 is shaped such that it is substantially capable of being attached to a central lingual surface of the patient's upper base plate 34 as shown in FIG. 11. The striking plate 28 may include one or more outwardly extending wings 36 capable of being trimmed by the clinician to properly fit the striking plate 28 between the occlusal surfaces of the upper base plate 34. The top surface 30 of the striking plate 28 may be removably attached by the attachment mechanism to the central lingual surface of the patient's upper base plate 34 such that the striking plate 28 is located slightly above the occlusal plane of the patient's upper base plate 34. In addition, the bottom surface 32 of the striking plate 28 may be aligned in parallel with the occlusal plane. The attachment material 42 may be any medical grade boding material, including but not limited to light-polymerized or auto-polymerizing materials, adhesive materials, bonding agents, dental waxes, medically approved super glues or other attachment materials commonly used in the dental industry. The striking plate 28 may be constructed of any polymeric or metal materials that will provide sufficient rigidity in order to prevent flexing of the striking plate 28 during dental measurements. The striking plate 28 may also have a rounded or beveled outer edge 46. Extending upwardly from the top surface 30 of the striking plate 28 may be one or more retention protrusions 56 that engage the patient's upper base plate 34. In an embodiment, the retention protrusions 56 take the form of upwardly extending crosses.

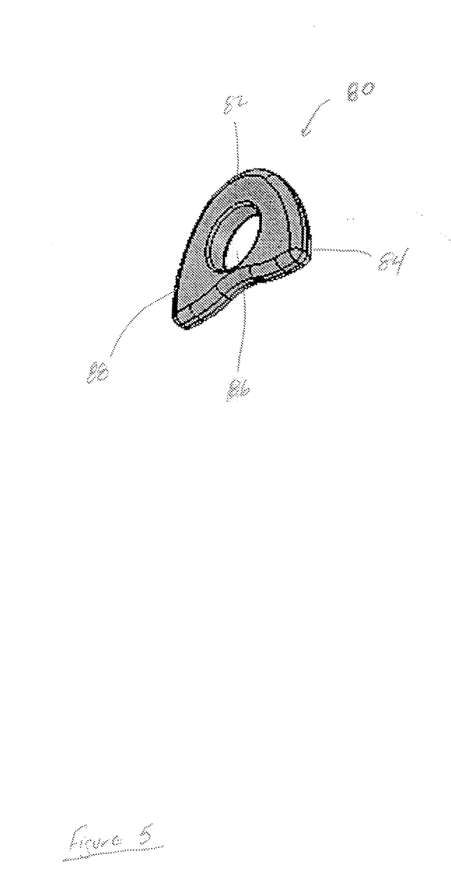

FIG. 5 illustrates a perspective view of an embodiment of a plate spacer 80 used with the occlusal device 10 of the present invention. The plate spacer 80 may include a top surface 82 and a bottom surface 84. The plate spacer 80 may have an opening 86 located substantially in the center to receive the post 38. The plate spacer 80 is adapted to fit over the shoulder 22 of the contact plate 12 while the bottom surface 84 of the plate spacer 80 lies flush with the top surface 14 of the contact plate 12. Similar to the contact plate 12 and the striking plate 28, the plate spacer may also have a rounded or beveled outer edge 88.

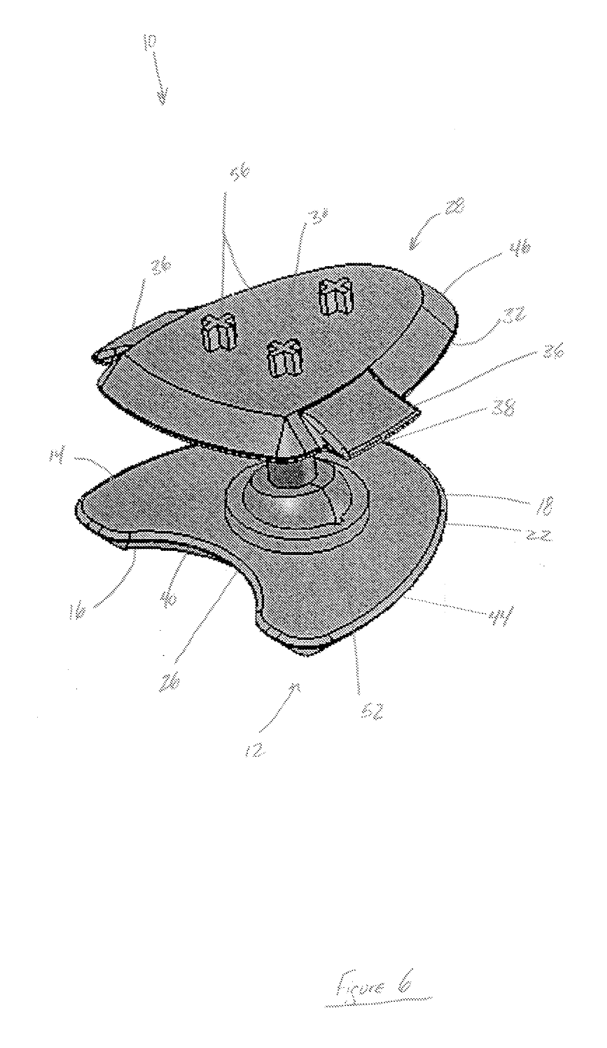

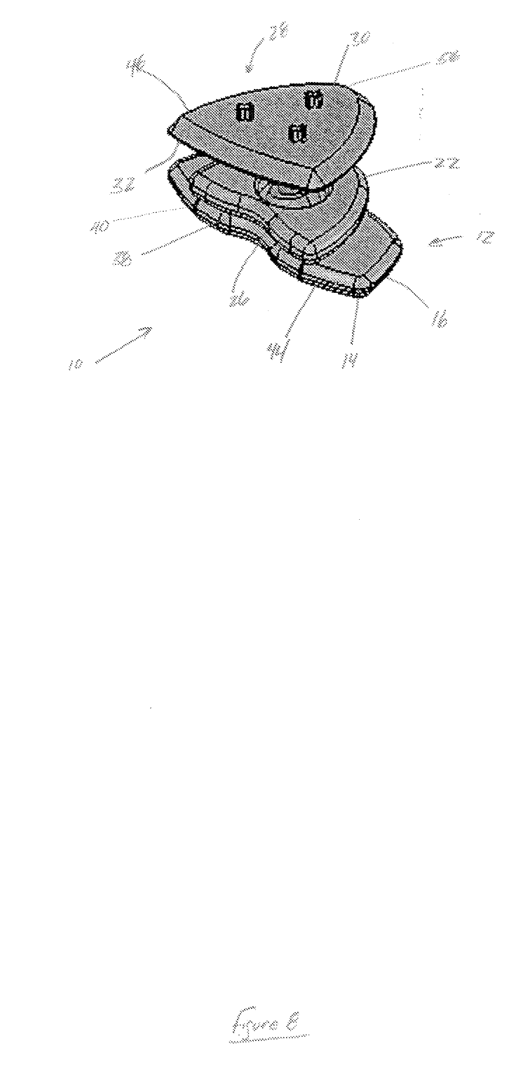

FIGS. 6 through 8 show perspective views of embodiments of the occlusal device 10 of the present invention. The combination of the contact plate 12, the post 38, the ball nut 26 and the striking plate 28 allows the clinician to accurately obtain the patient's OVD, CRP and other dental measurements. As can be seen, the sizes and shapes of the striking plate 28, the contact plate 12 and the plate spacer can be varied based on the individual needs of the patient. The contact plate 12 has a substantially centrally located tapered opening 18 which is adjustably connected to the ball nut 26. In addition to the tapered opening 18, the ball nut 26 is retained in place by the upwardly extending shoulder 22 on the top surface 14 of the contact plate 12. The tapered face 24 of the shoulder 22 and tapered opening 18 cooperate to attach the ball nut 26 such that the ball nut 26 swivels. The ball nut 26 may have a cylindrical bore within which the post 38 is adjustably secured. The ball nut 26 and the post 38 may be aligned to contact the striking plate 28 when the desired dental measurement is achieved. The striking plate 28 may include one or more outwardly protruding wings 36 capable of being trimmed so the striking plate 28 properly fits between the occlusal surfaces of the patient. The top surface 30 of the striking plate 28 may also have one or more retention protrusions 56 to engage the patient's mouth. As can be seen from FIG. 8, the occlusal device 10 may also include a plate spacer adapted to fit flush with the contact plate 12.

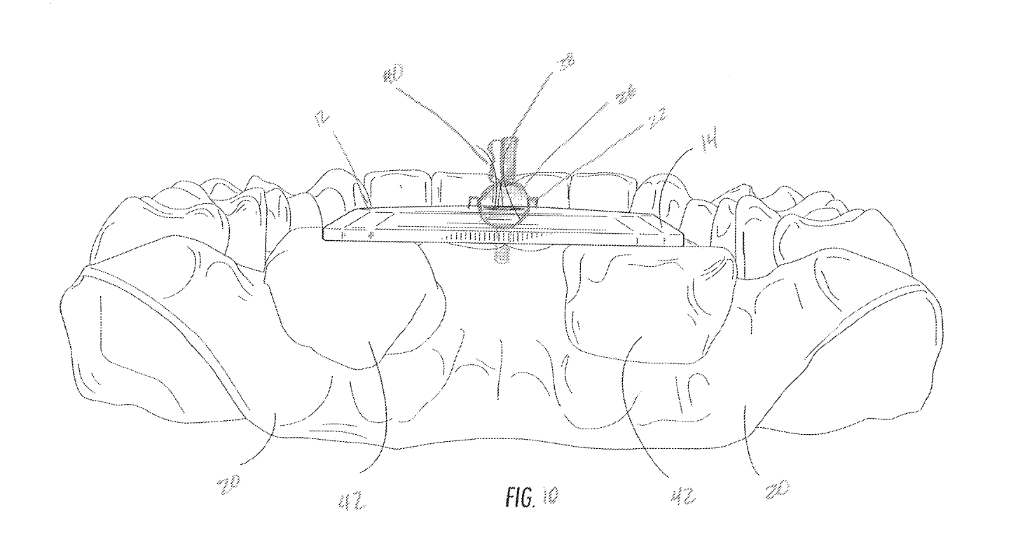

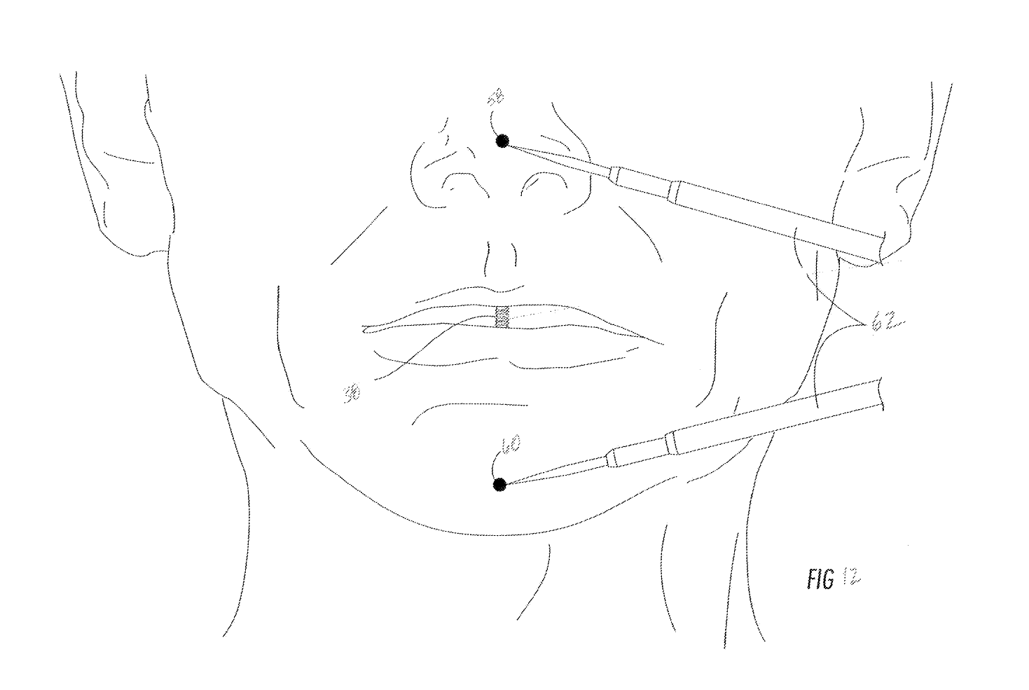

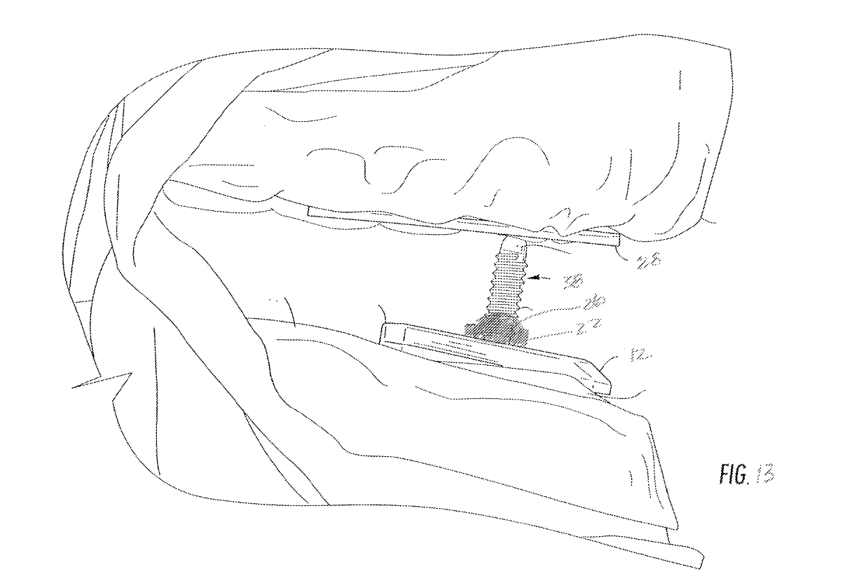

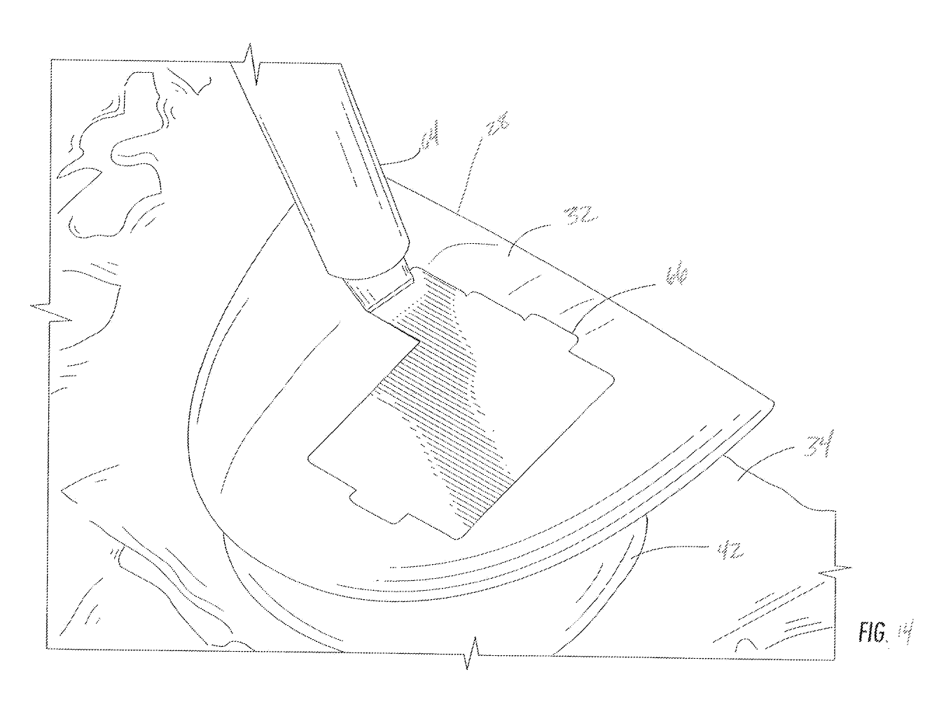

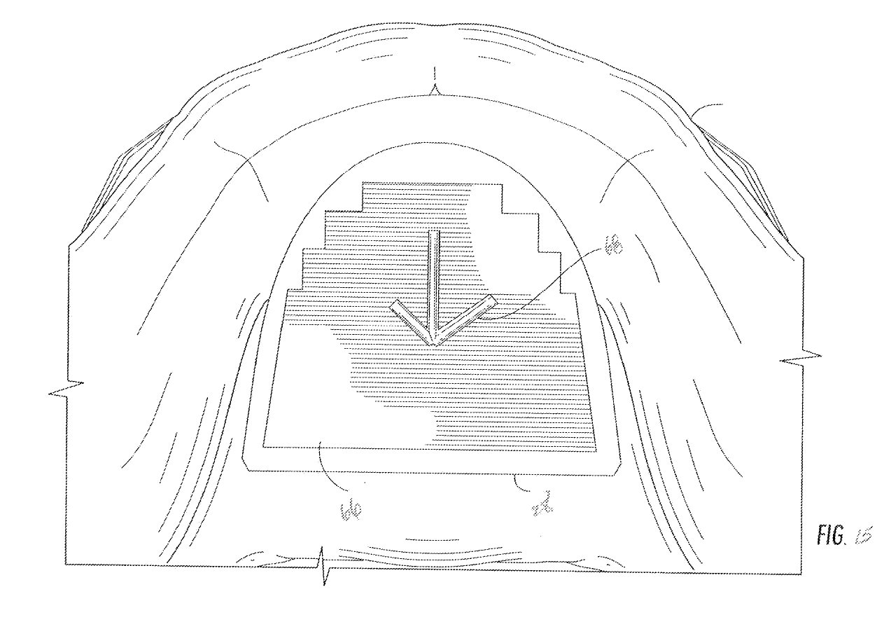

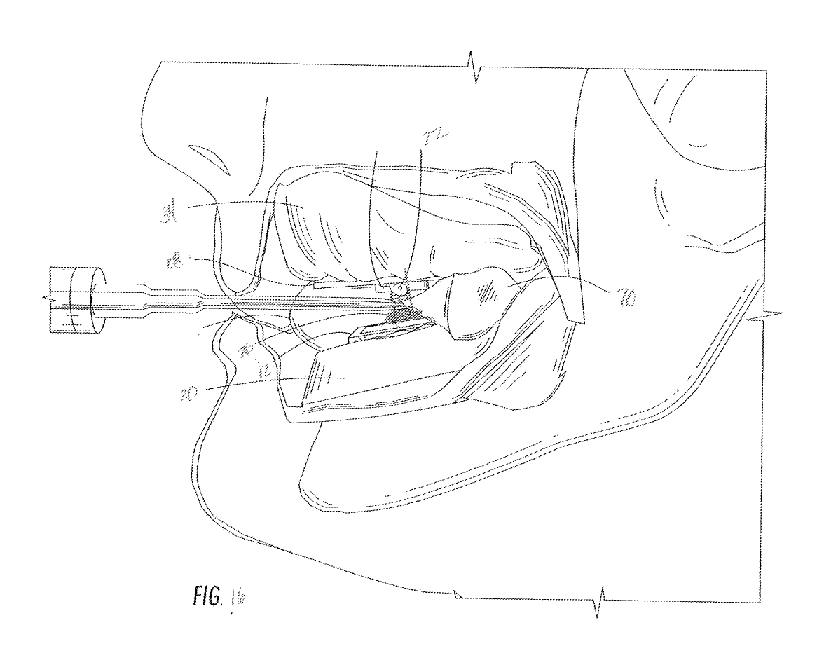

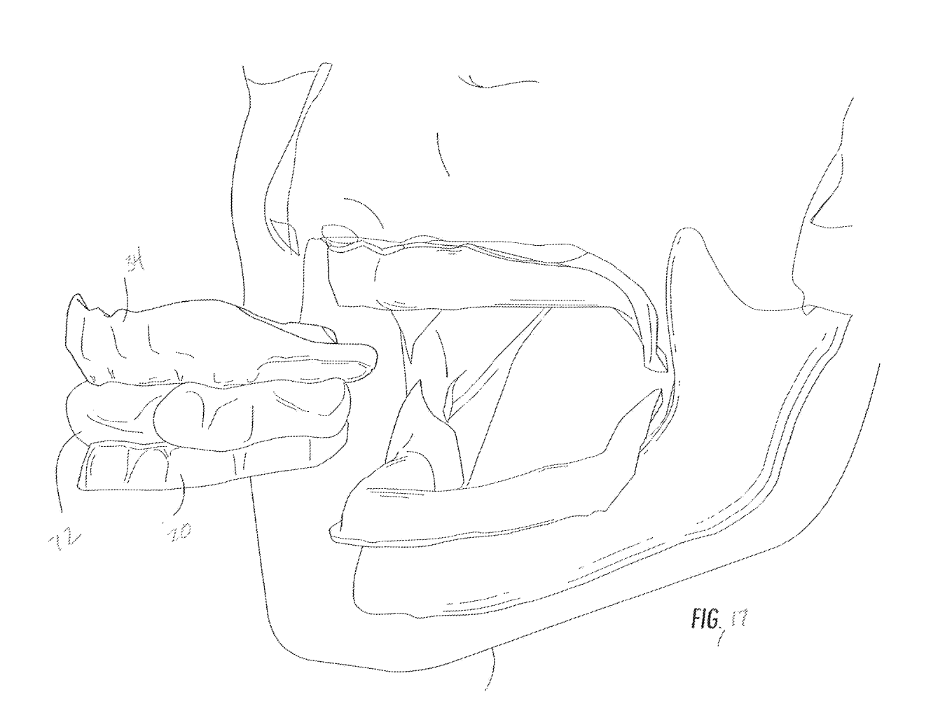

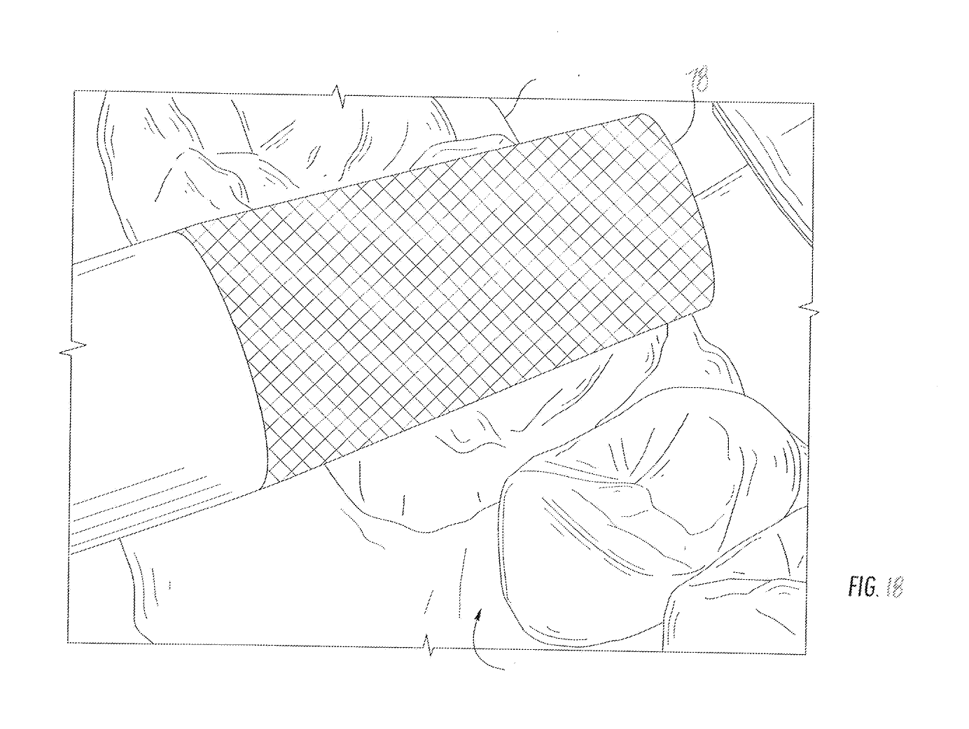

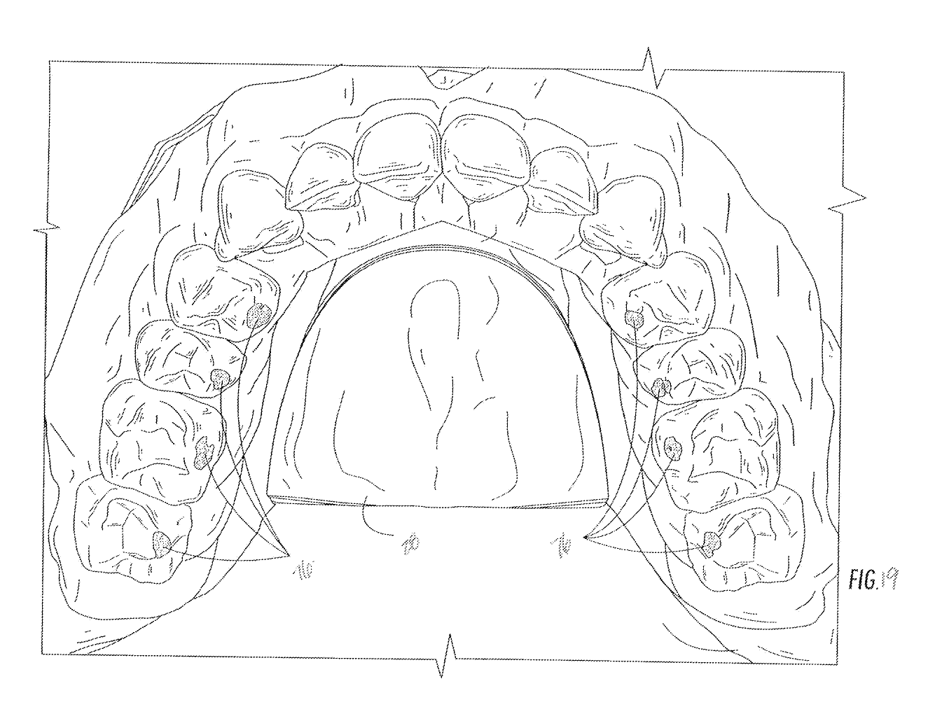

The clinician may perform the following method of using the occlusal device 10 for diagnostic evaluation of maxillomandibular relationships in the edentulous patient, as shown in FIGS. 9 through 19:

a. attaching a contact plate 12 to a central lingual surface of a lower base plate 20 using an attachment material 42 such that the contact plate 12 is slightly below the occlusal plane of the patient;

b. attaching a striking plate 28 to a central lingual surface of an upper base plate 34 using the attachment material 42 such that the contact plate 12 is slightly above the occlusal plane of the patient; wherein a plurality of retention protrusions 56 extend from a top surface 30 of the striking plate 28 to engage the upper base plate 34 of the patient;

c. fitting the striking plate 28 between the occlusal surfaces of the upper base plate 34 by trimming at least one wing outwardly extending from the striking plate 28;

d. securing a post 38 into a ball nut 26, the post 38 having a length 40 relative to a top surface 14 of the contact plate 12, and the ball nut 26 swivelably attached to a tapered opening 18 in the contact plate 12;

e. mounting the upper base plate 34 and the lower base plate 20 in the oral cavity of the patient;

f. aligning the upper base plate 34 and the lower base plate 20 using a plate spacer having a hole there through to receive the post 38 while the plate spacer is adapted to lie flush with the top surface 14 of the contact plate 12;

g. measuring the physiological rest position of the patient by placing a dot 58 and 60 on the nose and chin of the patient as measurement points with a non-permanent marker;

h. aiding complete relaxation of the jaw muscles by instructing the patient to take a series of deep breaths until the patient is fully relaxed; and

i. recording the physiological rest position of the patient by adjusting a caliper 62 so that the points of each leg of the caliper 62 touches the dots 58 and 60 on the nose and chin; and

j. locking the caliper 62 into the physiological rest position for future reference.

k. adjusting the length 40 of the post 38 until a terminal end of the post 38 will contact a bottom surface 32 of the striking plate 28 nearest to the point of the physiological rest position of the patient;

l. swiveling the ball nut 26 until the post 38 is substantially perpendicular to the striking plate 28 when the physiological rest position is maintained by the patient;

m. positioning the caliper 62 such that the legs touch the dots 58 and 60 on the nose and chin of the patient; and

n. decreasing the freeway space of the patient by adjusting the length 40 of the post 38 inside the physiological rest position represented by the caliper 62;

o. applying ink 66 from an inking mechanism 64 onto the bottom surface 32 of the striking plate 28;

p. establishing a repeatable centric relation position with the upper base plate 34 and the lower base plate 20 by instructing the patient to first tap the post 38 against the striking plate 28, and second, while maintaining contact between the terminal end of the post 38 and the bottom surface 32 of the striking plate 28, instruct the patient to move the jaw forward and backward and from side to side until the centric relation position is traced in the shape of an arrow, thus establishing the occlusal vertical dimension and the centric relation;

q. aligning the terminal end of the post 38 with the center point of the arrow by swiveling the ball nut 26, resetting the physiological rest position, or a combination of both; and

r. securing the ball nut 26 into a fixed position using an adhesive material 34.

s. injecting a bite registration material 70 between the upper base plate 34 and the lower base plate 20 while the patient maintains contact between the post 38 and the striking plate 28;

t. adjusting the length 40 of the post 38 so that the terminal end of the post 38 contacts the striking plate 28 when the teeth of the patient are held just out of occlusion in all mandibular movements allowing analyzation of premature contact between the teeth of the patient;

u. placing a marking material 74 above the occlusal surface of the patient;

v. instructing the patient to tap and rub the teeth of the patient together;

w. removing the marked cusps or fossae until proper occlusion is reached on all posterior teeth;

Whereas, the present invention has been described in relation to the drawings attached hereto, it should be understood that other and further modifications, apart from those shown or suggested herein, may be made within the spirit and scope of this invention.

What is claimed is:

1. An occlusal device for diagnostic evaluation of maxillomandibular relationships in edentulous patients, comprising:
a contact plate having a top surface and a bottom surface, said contact plate having a tapered opening located substantially in the center of said contact plate, said contact plate having a shape substantially capable of being attached to a central lingual surface of a lower base plate of said patient;
an upwardly extending shoulder surrounding said tapered opening, said shoulder extending from said top surface of said contact plate, and said shoulder having a tapered surface cooperating with said tapered opening of said contact plate to swivelably attach a ball nut to said contact plate;
a striking plate having a top surface and a bottom surface, said striking plate having a shape substantially capable of being attached to a central lingual surface of an upper base plate of said patient, said striking plate having a plurality of outwardly extending wings, wherein said wings are capable of being trimmed such that said striking plate properly fits between the occlusal surfaces of said upper base plate of said patient;
a post being adjustably secured to said ball nut such that a length of said post exposed in relation to said top surface of said contact plate; and
wherein the combination of said contact plate attached to said lower base plate, said ball nut swivelably attached to said tapered opening of said contact plate, said post adjustably secured in said ball nut, and said striking plate attached to said upper base plate, are received in the mouth of said patient such that said combination cooperate to accurately obtain said patient's occlusal vertical dimension, centric relation and other dental measurements.

2. The occlusal device of claim 1 wherein said contact plate and said striking plate are removably attached by an attachment material to said respective central lingual surface of said patient.

3. The occlusal device of claim 2 wherein said contact plate is located slightly below the occlusal plane of said lower base plate such that said top surface of said contact plate is substantially parallel to the occlusal plane of said lower base plate of said patient.

4. The occlusal device of claim 2 wherein said striking plate is located slightly above the occlusal plane of said upper base plate of said patient such that said bottom surface of said striking plate is substantially parallel to the occlusal plane of said upper base plate of said patient.

5. The occlusal device of claim 2 wherein said attachment material comprises a medical grade bonding material.

6. The occlusal device of claim 5 wherein said bonding material is selected from the group consisting of a light-polymerizing material, an auto-polymerizing material, an adhesive material, a bonding agent, a dental wax or a medically approved super glue.

7. The occlusal device of claim 1 wherein said contact plate and said striking plate are sufficiently rigid to prevent flexing while taking said dental measurements of said patient.

8. The occlusal device of claim 1 wherein an outer edge of said contact plate and said striking plate is rounded or beveled.

9. The occlusal device of claim 1 wherein said tapered opening has a top diameter near said top surface of said contact plate larger than a bottom diameter near said bottom surface of said contact plate.

10. The occlusal device of claim 1 wherein said tapered opening has at least one notch capable of receiving an adhesive material to immobilize said ball nut prior to taking said dental measurements of said patient.

11. The occlusal device of claim 10 wherein said adhesive material is a medically approved super glue.

12. The occlusal device of claim 1 wherein said shoulder is cylindrical.

13. The occlusal device of claim 1 wherein said top surface of said striking plate has at least one retention protrusion.

14. The occlusal device of claim 20 wherein said retention protrusion engages said upper base plate of said patient.

15. The occlusal device of claim 20 wherein said retention protrusion comprises at least one upwardly extending cross.

16. The occlusal device of claim 1 wherein said post is cylindrical in shape and has a threaded exterior surface, said ball nut having a threaded, cylindrical bore, wherein said threads in said ball nut cooperate with said threads of said post allowing said post to be adjustably captured in said ball nut, and said post is further adapted to remove ink from said bottom surface of said striking plate when said post contacts said striking plate at a desired occlusal vertical dimension.

17. The occlusal device of claim 1 further comprising a plate spacer having a top surface and a bottom surface, said plate spacer having an opening located substantially in the center to receive said post and said shoulder, and said plate spacer adapted to lie flush with said top surface of said contact plate.

18. The occlusal device of claim 27 wherein an outer edge of said plate spacer is rounded or beveled.

19. A method of using an occlusal device for diagnostic evaluation of maxillomandibular relationships in edentulous patients, comprising the steps of:
a. attaching a contact plate to a central lingual surface of a lower base plate using an attachment material such that said contact plate is slightly below the occlusal plane of said patient;
b. attaching a striking plate to a central lingual surface of an upper base plate using said attachment material such that said striking plate is slightly above the occlusal plane of said patient;
c. fitting said striking plate between the occlusal surfaces of said upper base plate of said patient by trimming at least one wing outwardly extending from said striking plate;
d. securing a post into a ball nut, said post having a length relative to a top surface of said contact plate, and said ball nut swivelably attached to a tapered opening in said contact plate;
e. mounting said upper base plate and said lower base plate in the oral cavity of said patient;
f. measuring the physiological rest position of said patient;
g. adjusting said length of said post until a terminal end of said post will contact a bottom surface of said striking plate nearest to the point of the physiological rest position of said patient;
h. swiveling said ball nut until said post is substantially perpendicular to said striking plate when the physiological rest position is maintained by said patient;
i. decreasing the freeway space of said patient by adjusting said length of said post;
j. establishing the occlusal vertical dimension, the centric relation position, or a combination of both the occlusal vertical dimension and the centric relation position, of said patient;
k. injecting a bite registration material between said upper base plate and said lower base plate while said patient maintains contact between said post and said striking plate;
l. removing said occlusal device from of said oral cavity of said patient once said bite registration material is sufficiently set; and
m. balancing said occlusal device in said oral cavity of said patient.

20. The method of using occlusal device of claim 19,
wherein step (b.) directed to attaching said striking plate is aided by a plurality of retention protrusions extending from said top surface of said striking plate to engage said upper base plate of said patient;
wherein step (e.) directed to mounting said upper base plate and said lower base plate in the oral cavity includes the step of aligning said upper base plate and said lower base plate using a plate spacer adapted to lie flush with said top surface of said contact plate, wherein said plate spacer has an opening therethrough to receive said post;
wherein step (g.) directed to measuring the physiological rest position of said patient further comprises the steps of:
i. placing a dot on the nose and chin of said patient as measurement points with a non-permanent marker;
ii. aiding complete relaxation of the jaw muscles by instructing said patient to take a series of deep breaths until said patient is fully relaxed;
iii. recording the physiological rest position of said patient by adjusting a caliper so that the points of each leg of said caliper touches said dots on the nose and chin; and
iv. locking said caliper into the physiological rest position for future reference;
wherein step (i.) directed to decreasing the freeway space further comprises the steps of:
i. positioning said caliper such that said legs touch said dots on the nose and chin of said patient; and
ii. decrease said length of said threaded post by one (1) to four (4) millimeters inside the physiological rest position represented by said caliper;
wherein step (j.) directed to establishing the occlusal vertical dimension and the centric relation position further comprises the steps of:
i. applying ink from an inking mechanism onto said bottom surface of said striking plate;
ii. establishing a repeatable centric relation position with said upper base plate and said lower base plate by instructing said patient to first tap said post against the striking plate, and second, while maintaining contact between said terminal end of said post and said bottom surface of said striking plate, instruct said patient to move the jaw forward and backward and from side to side until the centric relation position is traced in the shape of an arrow;
iii. aligning said terminal end of said threaded post with the center point of said arrow by swiveling said ball nut, resetting the physiological rest position, or a combination of both; and
iv. securing said ball nut into a fixed position using an adhesive material;
wherein said step of (m.) directed to balancing said occlusal device in said oral cavity further comprises the steps of:
i. adjusting said length of said post so that said terminal end of said post contacts said striking plate when the teeth of said patient are held just out of occlusion in all mandibular movements allowing analyzation of premature contact between said teeth of said patient;
ii. placing a marking material above the occlusal surface of said patient;
iii. instructing said patient to tap and rub the teeth of said patient together; and
iv. removing the marked cusps or fossae until proper occlusion is reached on all posterior teeth.
